(19) United States
(12) Patent Application Publication
(10) Pub. No.: US 2016/0370539 A1
(43) Pub. Date: Dec. 22, 2016

(54) REINFORCEMENT STRUCTURE FOR OPTICAL FILM AND OPTICAL FILM FOR APPLICATION THEREOF

(71) Applicant: BOE TECHNOLOGY GROUP CO., LTD., Beijing (CN)

(72) Inventors: Yongda Ma, Beijing (CN); Xinyin Wu, Beijing (CN); Yong Qiao, Beijing (CN)

(21) Appl. No.: 14/761,964

(22) PCT Filed: Mar. 16, 2015
(86) PCT No.: PCT/CN15/74285

§ 371 Date: Sep. 6, 2016

(30) Foreign Application Priority Data
Oct. 21, 2014 (CN) 201420611045.8

(51) Int. Cl. F21V 8/00

(52) U.S. Cl. CPC G02B 6/0093; G02B 6/0088

(57) ABSTRACT

The present disclosure discloses a reinforcement structure for an optical film and an optical film for application therewith, which relate to the technical field of liquid crystal display modules, so as to solve the problem that the positioning hole in a prior art optical film is easily deformable or damageable. A reinforcement structure for an optical film is disclosed, which is arranged around a positioning hole in the optical film, for enhancing the structural strength of the positioning hole. The present disclosure can be applied in a liquid crystal display module.

### FIELD

The present disclosure relates to the technical field of liquid crystal display modules and, in particular, to a reinforcement structure for an optical film and an optical film for application therewith.

### BACKGROUND

In the prior art, an optical film is usually provided thereon with a positioning hole and a positioning pillar, which hole and pillar cooperate together to function for positioning the optical film. As liquid crystal displays and television sets grow constantly in size, the size of an optical film applied in a liquid crystal backlight module increases as well. Since the dimensions of the positioning hole and the positioning pillar are restricted by the borders of the liquid crystal display module, they cannot increase in a corresponding manner. While the size of the optical film increases, and the dimensions of the positioning hole and the positioning pillar remain unchanged, the positioning hole is fragile to deformation or damage due to the increased force exerted on the positioning hole.

### SUMMARY

It is an embodiment of the present disclosure to provide a reinforcement structure for an optical film and an optical film for application therewith, so as to solve the problem that the positioning hole in a prior art optical film is easily deformable or damageable.

In order to achieve the above object, in a first aspect of the present disclosure, a reinforcement structure for an optical film is provided, which reinforcement structure may be arranged around a positioning hole in the optical film and/or on a positioning pillar in the optical film, for enhancing the structural strength of the positioning hole and/or the positioning pillar.

In one embodiment of the present disclosure, the reinforcement structure may comprise at least one of a reinforcement rib and a reinforcement ring.

Therein, the reinforcement structure may be made from an organic thin film or made from the same material as the optical film.

In another embodiment of the present disclosure, the reinforcement structure and the optical film may be adhesively connected or connected by hot pressing.

Therein, when the reinforcement structure is arranged around the positioning hole, the reinforcement structure may be shaped the same as the positioning hole.

In a further embodiment of the present disclosure, the reinforcement structure may be adhesively connected via an adhesive tape with the optical film.

Therein, a surface of the reinforcement structure may be provided with a glue layer, the glue layer being adhesively connected around the positioning hole and/or on the positioning pillar.

In a yet further embodiment of the present disclosure, the reinforcement structure may be arranged on at least one of a frontal and a back of the optical film.

In a second aspect of the present disclosure, an optical film is provided, with the above-said reinforcement structure being provided around a positioning hole in the optical film and/or on a positioning pillar.

Therein, the frontal and the back of the optical film are both provided with the reinforcement structure.

The reinforcement structure for an optical film and the optical film for application therewith, as provided by the embodiments of the present disclosure, can be arranged around a positioning hole in the optical film and/or on a positioning pillar in the optical film, for enhancing the structural strength of the positioning hole and/or the positioning pillar. For example, the reinforcement structure may be arranged on a frontal or a back of the optical film, or alternatively, both the frontal and the back may be arranged with the reinforcement structure. The reinforcement structure around the positioning hole can enhance the structural strength of the positioning hole, while the reinforcement structure on the positioning pillar can enhance the structural strength of the positioning pillar; when the positioning hole and the positioning pillar are mated, the reinforcement structure is able to effectively avoid deformation or damage due to insufficient strength in positioning.

### BRIEF DESCRIPTION OF THE DRAWINGS

FIG. 1 is a schematic diagram of a reinforcement structure for an optical film provided by an embodiment of the present disclosure;

FIG. 2 is a schematic diagram of another reinforcement structure for an optical film provided by an embodiment of the present disclosure;

FIG. 3 is a schematic diagram of a further reinforcement structure for an optical film provided by an embodiment of the present disclosure;

FIG. 4 is a schematic diagram of a yet further reinforcement structure for an optical film provided by an embodiment of the present disclosure.

### DETAILED DESCRIPTION

The embodiments of the present disclosure will be described in detail as follows in conjunction with the accompanying drawings.

In the description of the present disclosure, it is to be understood that the terms “frontal”, “back”, etc. indicate locations or positional relationships that are shown based on what are shown in the drawings, which are aimed only at facilitating the description the present disclosure and simplifying the description, rather than indicating or implying that relevant means or elements must be provided with particular locations, or constructed and operated at the particular locations, and accordingly cannot be understood as limitations to the present disclosure.

In the description of the present disclosure, it is to be understood that unless prescribed and defined otherwise, the terms “mounted”, “linked” and “connected” should be understood in a broad sense, e.g. it can be a fixed or detachable connection, or alternatively an integral connection; it can be direct connection or connection via an intermediate medium, or internal communication of two elements. For an ordinarily skilled in the art, the above terms can be understood specifically according to specified circumstances in the present disclosure.

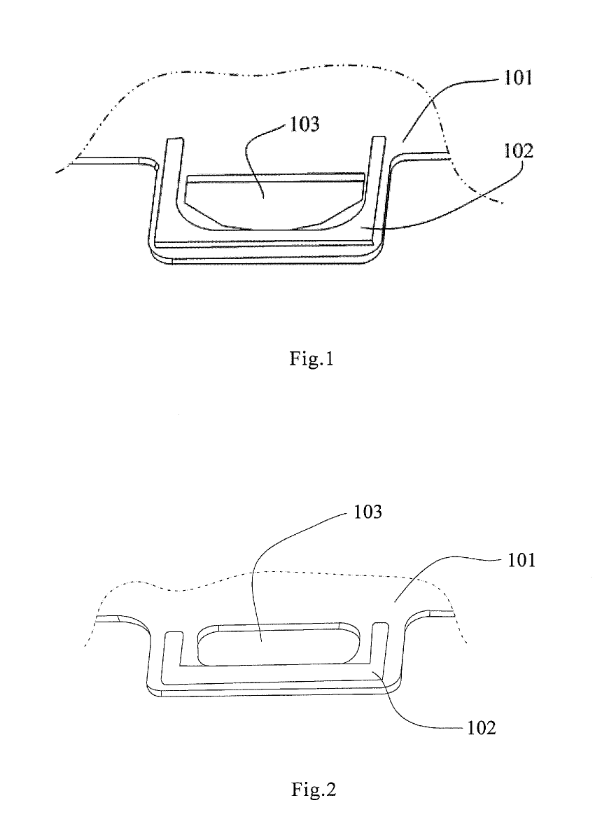

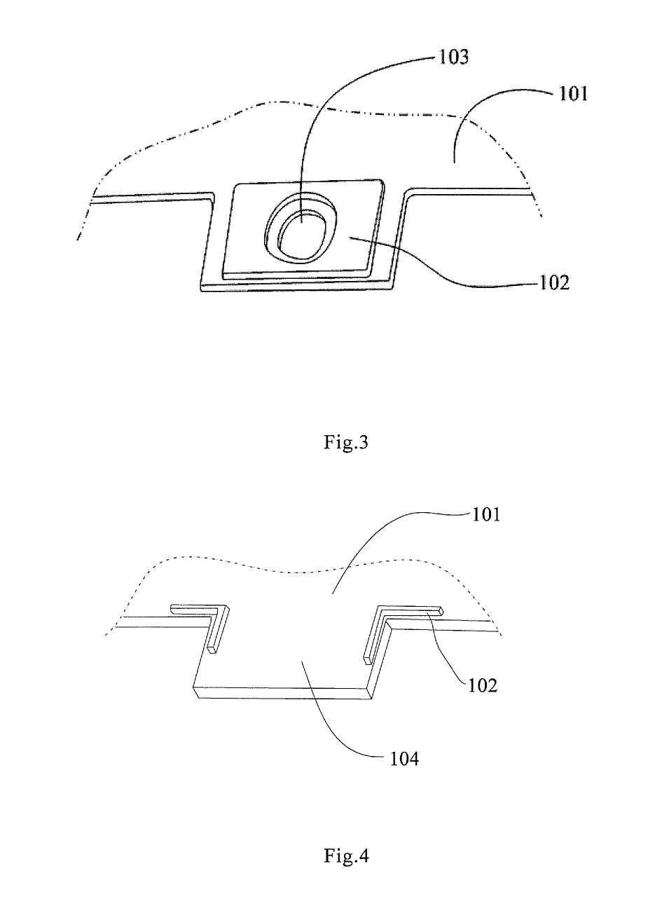

Referring to FIG. 1, FIG. 2 and FIG. 3, in an embodiment of the present disclosure a reinforcement structure 102 for an optical film is provided, which is arranged around a positioning hole 103 in the optical film 101, for enhancing the structural strength of the positioning hole 103. For example, the reinforcement structure 102 can be arranged on a frontal or a back of the optical film 101, or arranged on both the frontal and the back thereof. The reinforcement structure 102 around the positioning hole 103 can enhance the structural strength of the positioning hole 103. When the positioning hole 103 is mated with a positioning pillar (not shown), the reinforcement structure 102 is able to effectively avoid deformation or damage due to insufficient strength in positioning.

The reinforcement structure 102 may comprise a reinforcement rib and a reinforcement ring. The reinforcement rib or reinforcement ring can better enhance the structural strength of the positioning hole 103. Moreover, the reinforcement rib and reinforcement ring can be easily available, of which the manufacturing processes are simple and low in cost.

The reinforcement structure 102 may be made from an organic thin film or made from the same material as the optical film 101. The organic thin film or the similar material to that of the optical film 101 is selected for manufacturing the reinforcement structure 102 so that a better match can be reached between the reinforcement structure 102 and the optical film 101, and accordingly, the effect of connection between the reinforcement structure 102 and the optical film 101 is improved thus enhancing the structural strength of the positioning hole 103.

The reinforcement structure 102 may be adhesively connected or connected by hot pressing with the optical film 101. For example, a surface of the reinforcement structure 102 may be provided with an adhesive layer, which layer is adhesively connected with the optical film 101 so as to effect a connection between the reinforcement structure 102 and the optical film 101; or, the reinforcement structure 102 and the optical film 101 are adhesively connected by an adhesive tape so as to effect a connection between the reinforcement structure 102 and the optical film 101. When the reinforcement structure 102 is made from the same material as the optical film 101, the reinforcement structure 102 and the optical film 101 can be connected by a hot pressing process, in which connection the reinforcement structure 102 and the optical film 101 are provided with a more stable connection thus enabling a better match between the reinforcement structure 102 and the optical film 101.

In addition, the reinforcement structure 102 may be shaped the same as the positioning hole 103 so that a better match can be reached between the reinforcement structure 102 and the positioning hole 103, and the appearance is more pleasant.

Therein, the reinforcement rib or reinforcement ring may be adhesively connected around the positioning hole 103 by an adhesive tape. Alternatively, a surface of the reinforcement rib or the reinforcement ring can be provided with a glue layer, and the glue layer is adhesively connected around the positioning hole 103 so as to effect a connection between the reinforcement structure 102 and the optical film 101.

In particular, the reinforcement structure 102 may be arranged on a frontal and a back of the optical film 101. Since both the frontal and the back of the optical film 101 are provided with the reinforcement structure 102 to enable a greater structural strength around the positioning hole 103, a deformation of or a damage to the positioning hole 103 can be effectively avoided.

Referring to FIG. 4, the reinforcement structure 102 may also be arranged on a positioning pillar 104 in the optical film 101 so that the structural strength of the positioning pillar 104 can be enhanced. In this way, the reinforcement structure 102 may be arranged on the positioning hole 103 and the positioning pillar 104 at the same time, such that the structural strengths of the positioning hole 103 and the positioning pillar 104 can be both enhanced thus improving further the capability of enduring a greater stress when the positioning hole 103 and the positioning pillar 104 are mated.

In an embodiment of the present application an optical film 101 is also provided, in which the above-said reinforcement structure 102 is arranged around a positioning hole. The reinforcement structure 102 is arranged around the positioning hole 103 in the optical film 101 for enhancing the structural strength of the positioning hole 103. For example, the reinforcement structure 102 may be arranged on a frontal or a back of the optical film 101, or arranged on both the frontal and the back thereof. The reinforcement structure 102 around the positioning hole 103 can enhance the structural strength of the positioning hole 103. When the positioning hole 103 is mated with a positioning pillar, the reinforcement structure 102 is able to effectively avoid deformation or damage due to insufficient strength of the positioning hole 103.

In particular, both the frontal and the back of the optical film 101 are provided with the reinforcement structure 102 so that the positioning hole 103 on the optical film 101 gains a better structural strength.

In this description, the specific features, structures, materials or characteristics can be combined in an appropriate manner in any one or more embodiments or examples.

Above are specific embodiments of the present disclosure only, while the scope of the present disclosure is not limited to these embodiments. Any skilled person familiar with the art can easily and readily conceive of a variation or replacement within the disclosed technical scope of the present disclosure, and the variation or replacement should be included in the scope of the present disclosure. Therefore, the scope of the present disclosure should be in accordance with the scope of the appended claims.

1-40. (canceled)

41. A reinforcement structure for an optical film, wherein the reinforcement structure is arranged around a positioning hole in the optical film and/or on a positioning pillar in the optical film.

42. The reinforcement structure for the optical film according to claim 41, wherein the reinforcement structure comprises at least one of a reinforcement rib and a reinforcement ring.

43. The reinforcement structure for the optical film according to claim 41, wherein the reinforcement structure is made from an organic thin film or made from the same material as the optical film.

44. The reinforcement structure for the optical film according to claim 42, wherein the reinforcement structure is made from an organic thin film or made from the same material as the optical film.

45. The reinforcement structure for the optical film according to claim 41, wherein the reinforcement structure and the optical film are adhesively connected or connected by hot pressing.

46. The reinforcement structure for the optical film according to claim 41, wherein the reinforcement structure is arranged around the positioning hole, and the reinforcement structure is shaped the same as the positioning hole.

47. The reinforcement structure for the optical film according to claim 41, wherein the reinforcement structure is adhesively connected via an adhesive tape with the optical film.

48. The reinforcement structure for the optical film according to claim 41, wherein a surface of the reinforcement structure is provided with a glue layer, the glue layer being adhesively connected around the positioning hole and/or on the positioning pillar.

49. The reinforcement structure for the optical film according to claim 41, wherein the reinforcement structure is arranged on at least one of a frontal and a back of the optical film.

50. An optical film, wherein the reinforcement structure according to claim 41 is provided around a positioning hole in the optical film and/or a positioning pillar in the optical film.

51. An optical film, wherein the reinforcement structure according to claim 42 is provided around a positioning hole in the optical film and/or a positioning pillar in the optical film.

52. An optical film, wherein the reinforcement structure according to claim 43 is provided around a positioning hole in the optical film and/or a positioning pillar in the optical film.

53. An optical film, wherein the reinforcement structure according to claim 44 is provided around a positioning hole in the optical film and/or a positioning pillar in the optical film.

54. An optical film, wherein the reinforcement structure according to claim 45 is provided around a positioning hole in the optical film and/or a positioning pillar in the optical film.

55. An optical film, wherein the reinforcement structure according to claim 46 is provided around a positioning hole in the optical film and/or a positioning pillar in the optical film.

56. An optical film, wherein the reinforcement structure according to claim 47 is provided around a positioning hole in the optical film and/or a positioning pillar in the optical film.

57. An optical film, wherein the reinforcement structure according to claim 48 is provided around a positioning hole in the optical film and/or a positioning pillar in the optical film.

58. An optical film, wherein the reinforcement structure according to claim 49 is provided around a positioning hole in the optical film and/or a positioning pillar in the optical film.

59. The optical film according to claim 49, wherein the frontal and the back of the optical film are both provided with the reinforcement structure.

60. The optical film according to claim 51, wherein the frontal and the back of the optical film are both provided with the reinforcement structure.
